(19) United States
(12) Patent Application Publication
(10) Pub. No.: US 2023/0408457 A1
(43) Pub. Date: Dec. 21, 2023

(54) COLUMN IN A MODULE WITH INTERNAL OR EXTERNAL ON-COLUMN OR FLOW CELL DETECTORS WITH OPTIONAL HEATING FOR LIQUID CHROMATOGRAPHY

(71) Applicant: AXCEND, LLC, Provo, UT (US)

(72) Inventors: Greg Ward, Cottonwood Heights, UT (US); Elisabeth Gates, Provo, UT (US); Paul B. Farnsworth, Highland, UT (US); Matthew Morse, Swansboro, NC (US); Milton L. Lee, Pleasant Grove, UT (US)

(21) Appl. No.: 18/338,270

(22) Filed: Jun. 20, 2023

Related U.S. Application Data
(60) Provisional application No. 63/353,817, filed on Jun. 20, 2022.

(51) Int. Cl. G01N 30/16; G01N 30/32; G01N 30/60; G01N 30/30

(52) U.S. Cl. CPC G01N 30/16; G01N 30/32; G01N 30/6034; G01N 30/30; G01N 2030/027

(57) ABSTRACT

A system and method for separating the functions of a liquid chromatography (LC) system into physically separate systems that allow for a more versatile LC system, wherein an LC device provides a liquid solvent, a sample, and a pump and injector that pushes the sample in the solvent to an output port, and provides an attachable module containing a module input port, a column, and a heating unit on the column, with the module providing either transparent, non-transparent columns, or a combination of both, and the system providing an on-column detector within the module, or flow cell detectors in the module, the LC device or external to the module and the LC device, and attaching the module to the LC device using a high pressure compression connection that enables the sample in the solvent to be pumped through the column to at least one detector in order to separate, identify and quantify substances in the sample and transmit results from the at least one detector to a computing system for collection and analysis.

### BACKGROUND

Description of Related Art: Liquid chromatography (LC) is performed in order to analyze the chemicals in a liquid solution. FIG. 1 is a block diagram of components that may be part of an LC system in the prior art that may include but should not be considered as limited to a container of solvent 10, a pump 12, an injector 14, a sample 16, a column 18, a heater unit 20, a detector 22 and a computing device 24 for data acquisition. Other components may also be needed, and the arrangement of specific components may be modified from that shown, but typically these components are used in an LC system.

The function of the LC system may proceed as follows. An LC system may use a pump to pass a pressurized liquid solvent containing a sample mixture through a column filled with a solid sorbent material. Each component in the sample interacts slightly differently with the sorbent material, thereby causing different migration rates for the different substances within the sample and leading to the separation of the substances as they flow out of the column.

When these instrumental components are being used in either a laboratory or portable setting, the state of the art requires that physical connections be made between the various components of the system. For example, consider the diagram shown in FIG. 2. FIG. 2 shows that there is a connection 30 between the injector 14 and the column 18.

The prior art was improved upon by providing an LC system wherein an LC device provides a liquid solvent, a sample, and a pump and injector that pushes the sample in the solvent to an output port, and then provides an attachable module containing a module input port, a column, and at least one detector for on-column detection, then attaching the module to the LC device using a press-fit connection that enables the sample in the solvent to be pumped through the column to at least one detector in order to separate, identify and quantify substances in the sample and transmit results from the at least one detector to the LC system for collection and analysis integrating a column and a detector in a module with on-column detectors.

It would be an advantage over the prior art to provide several improvements that increase the versatility and sensitivity of the LC system. For example, it would be an improvement to provide a system and method for heating a column while it is within a module to thereby provide controlled and above-ambient column temperatures.

The module of the prior art was also limited to providing a capillary column for on-column detection. Therefore, it would be a further advantage to have an LC system that provides a module that can contain a variety of different columns including non-transparent columns and is not limited to just UV or Visible light detection using a transparent capillary column.

Along with providing non-transparent columns in the module, a variety of detectors may then be used including flow cell detectors that were previously not supported. It would be another advantage if the flow cell detectors could be disposed internally to the module, internal to the LC device, or external to them both depending on the size of the flow cell detector.

### BRIEF SUMMARY

The present invention is a system and method for separating the functions of a liquid chromatography (LC) system into physically separate systems that allow for a more versatile LC system, wherein an LC device provides a liquid solvent, a sample, and a pump and injector that pushes the sample in the solvent to an output port, and provides an attachable module containing a module input port, a column, and a heating unit on the column, with the module providing either transparent, non-transparent columns, or a combination of both, and the system providing an on-column detector within the module, or flow cell detectors in the module, the LC device or external to the module and the LC device, and attaching the module to the LC device using a high pressure compression connection that enables the sample in the solvent to be pumped through the column to at least one detector in order to separate, identify and quantify substances in the sample and transmit results from the at least one detector to a computing system for collection and analysis.

In a first aspect of the invention, it would be an advantage to be able to have a heating unit on the full length or just a portion of the length of the column in the module.

In a second aspect of the invention, non-transparent or opaque columns may also be used in the module to provide a wider variety of testing capabilities.

In a third aspect of the invention, flow cell detectors may be used in the LC system.

In a fourth aspect of the invention, the flow cell detectors would be placed internal to the module, internal to the LC device, or external to both the module and the LC device.

In a fifth aspect of the invention, multiple columns may be coupled in series, with the columns being transparent columns, non-transparent columns, or a combination of transparent and non-transparent columns.

In a sixth aspect of the invention, detectors may be disposed at the junction between columns.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of components that may be part of a liquid chromatography system of the prior art.

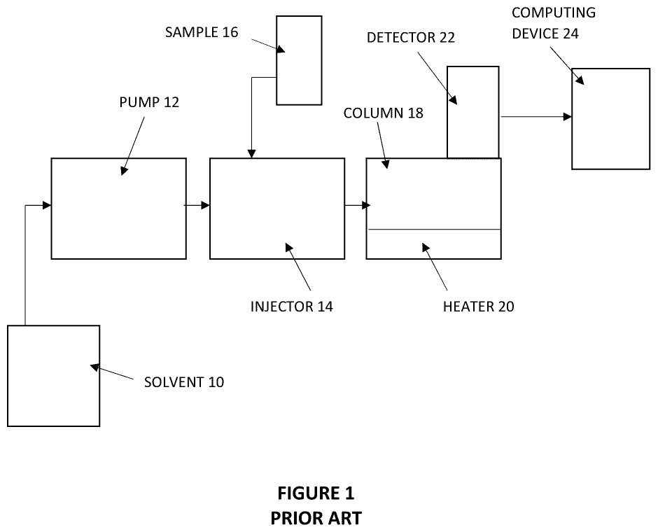

FIG. 2 is a diagram showing a prior art liquid chromatography system that requires manual connections to be made between various components of the LC system.

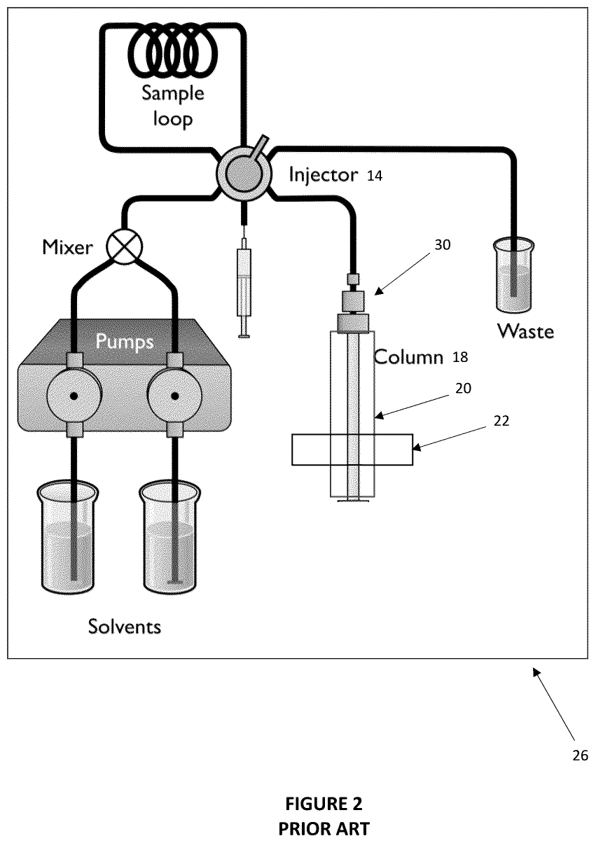

FIG. 3 is a perspective view of an LC system of the prior art that includes an LC device and a replaceable module, wherein the module includes a column and at least one detector or a path to an external detector.

FIG. 4 is a perspective view of the prior art that is constructed in accordance with the aspects of the invention.

FIG. 5 is a perspective view of a first embodiment of the present invention with the cover removed to show a first arrangement of components inside the module.

FIG. 6 is an alternative embodiment that places the detector in the LC device.

FIG. 7 is an alternative embodiment that places the detector external to the module and the LC device.

FIG. 8 is a diagram that shows operation of a Z flow cell detector that may be disposed within the module.

### DETAILED DESCRIPTION

Reference will now be made to the drawings in which the various embodiments of the present invention will be given numerical designations and in which the embodiments will be discussed so as to enable one skilled in the art to make and use the invention. It is to be understood that the following description illustrates embodiments of the present invention and should not be viewed as narrowing the claims which follow.

The present invention may be usable with a liquid chromatography (LC) system for separating, identifying and quantifying each component in a sample mixture.

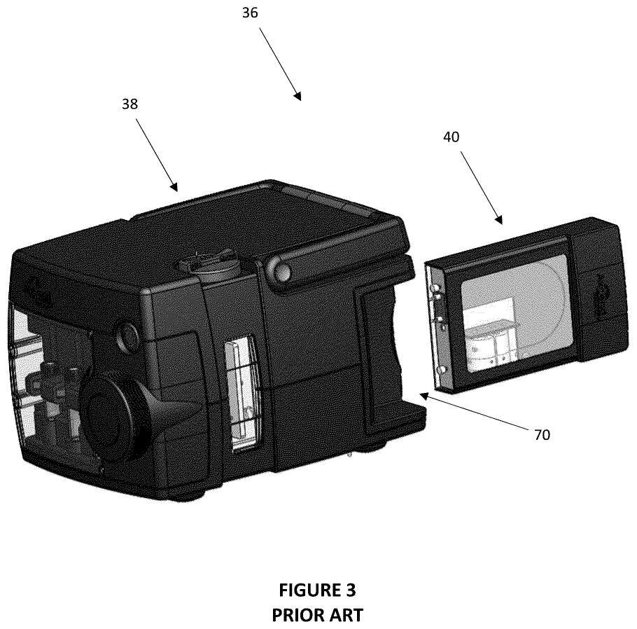

FIG. 3 is a perspective view of the prior art showing an LC system 36 including an LC device 38 and a module 40. The LC device 38 may include some components such as a pump, a pump reservoir for solvents, an injector, a sample, and a battery. The LC device 38 may include fewer components or may also include additional components and should not be considered as limited to the components described above.

The LC system 36 also includes the module 40. The module 40 may include a housing that enables the module to be attached to the LC device 38, and to protect components disposed within the module.

In the prior art, the connection system between the LC device 38 and the module 40 is a critical aspect of the invention. In order to provide a reliable and repeatable connection system, a slot 70 is provided in the LC device 38 to enable pre-alignment between the LC device 38 and the module 40 to safely guide the module to connection points on the LC device. The slot 70 also enables the connection points of the LC device 38 and the module 40 to meet in a straight on approach.

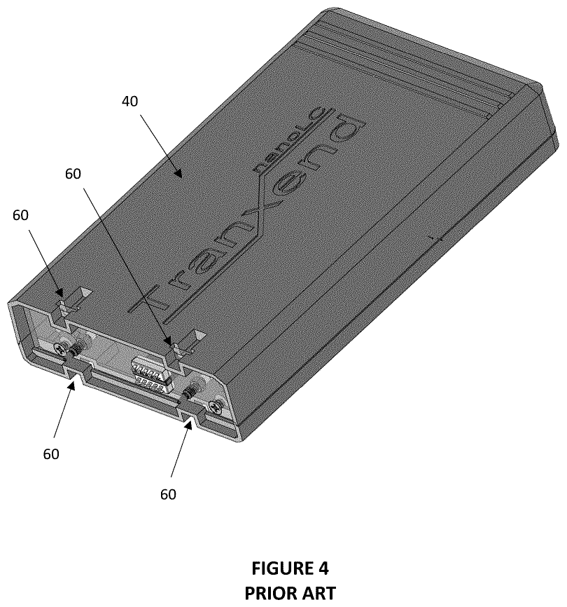

Before describing these connection points in more detail, it is useful to describe the module 40 of the prior art. FIG. 4 is a perspective view of a module 40 with a cover over the components that are disposed inside.

The housing of the module 40 may be used to attach the module to the LC device 38, but it should be understood that the attachment points are not being relied upon for making a leak-free press-fit connection. For example, the LC device 38 may have corresponding latches that engage a plurality of latch ports 60 shown in the module 40.

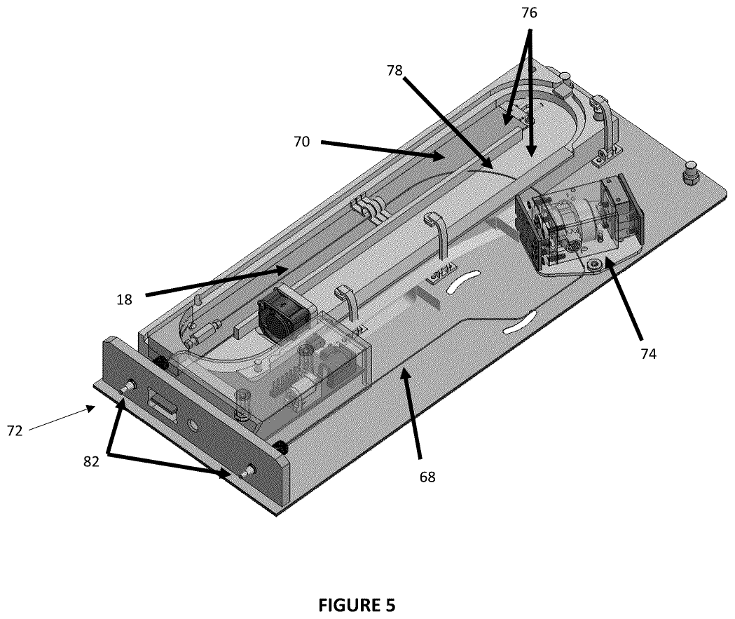

FIG. 5 is a perspective view of a first embodiment of the present invention with the cover removed to show a first possible arrangement of components inside the module 40. The specific arrangement of components is not important and should not be considered to limit the scope of the claims to follow.

The module 40 may include a connection end 72 that is seated against a corresponding connection end of the LC device 38. FIG. 5 also shows a column 18 that is curved towards a detector 74. In this first embodiment, the column 18 may have a portion that is within a column oven 76. The column 18 then leaves the column oven 76 and passes to the detector 74. Typically, the column 18 ends when it leaves the column over 76 and is replaced by a transfer line 78. The transfer line 78 transfers the solvent and the sample to the detector that is positioned outside of the module 40.

The ability of the first embodiment to include non-transparent columns in the module 40 means that detectors other than on-column detectors may also be a part of the LC system 36. However, other types of detectors are not required. Therefore, the addition of non-transparent columns does not mean that the LC system 36 cannot continue to perform on-column detection. It would require that columns be connected in series and that at least one column is transparent. However, if only non-transparent columns are being used in a module, then either flow cell detectors or other non-flow cell type detectors would have to be used.

In this particular example, the detector 74 is a UV absorption flow cell detector. It is too large to fit inside the module 40 and is therefore disposed outside the module. However, it should be understood that the type of detector may vary without changing the scope of the claims.

The module 40 in FIG. 5 has been modified to include other features that are also different from the prior art. First, the prior art module 40 required a press-fit connection between the module and the LC device 38. In contrast, the first embodiment may use any connector 82 that provides a high pressure seal that uses compression and is thus a high pressure compression connection. This may be a press-fit connector or a quick-connect type of connector. What is important is that the connector is not limited to a press-fit connector.

The module 40 of the first embodiment now includes a heating unit 70 on the full length or just a portion of the length of the column 18. The heating unit 70 may be disposed within a column oven 76 of the module 40. The column oven 76 may be sealed when the cover of the module 40 is attached to the module. The column 18 may include the transfer line 78 that delivers the sample to the flow cell detector 74. The module 40 may also include a waste line 80 that sends the sample back to the LC device 38 after it has passed through the detector 74.

To increase versatility of the module 40, a growing number of separation columns and packing media are available from a variety of vendors. These may be placed in series to obtain the benefits of using them to obtain the desired separation and detection characteristics.

Another feature of the first embodiment is the ability to use many of the different types of columns that are available on the market, and not just transparent columns that are used for on-column detection as in the prior art. These other columns include non-transparent or opaque columns that are unsuitable for on-column detection. For example, some other columns include an opaque coating or are made of an opaque material. Other columns may have a sheath of a non-transparent material. Accordingly, most columns having an OD of approximately 1 mm or less may be used within the first embodiment of the module 40. This means that any capillary or near capillary size columns may be used in the module 40.

As stated previously, while the prior art was limited to on-column UV or fluorescence detectors, the first embodiment may use a variety of flow cell detectors that use a flow of fluid that travels through a detector beam path. The first embodiment may also use detectors that are not on-column or flow cell detectors. These are detectors such as mass spectrometers or ion mobility detectors.

Examples of flow cell detectors include but are not limited to UV absorption detectors, photodiode array detectors, fluorescence detectors, electrochemical detectors, electrical conductivity detectors and refractive index detectors. Accordingly, another aspect of the first embodiment is that the flow cell detector 74 may be disposed internally within the module 40, internally within the LC device 38, or it may be disposed external to the module and the LC device if it is too large.

It is noted that when the flow cell detector is disposed external to the module 40 and the LC device 38, a transfer line 78 may be coupled to the column 18 and extend out the side or back of the module to reach the detector that is typically placed in close proximity.

One aspect of the first embodiment is that columns used in the present invention do not have to be a monolithic device. In other words, two different types of columns may be coupled in series in order to obtain the benefits of different columns. For example, an opaque column 18 may be coupled to a transparent column in order to perform on-column detection. In addition, a detector may be disposed between the different columns. This may be useful to determine, for example, the length of time that it takes for particular samples to travel through different columns.

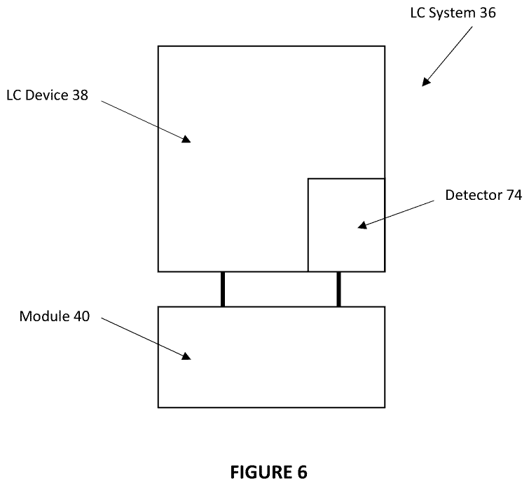

The prior art teaches that the LC system shown in FIG. 3 is only divided into two separate components, the LC device 38 and the module 40 that together include all of the necessary elements to perform liquid chromatography. However, in a second embodiment shown in a block diagram in FIG. 6, the LC device 38 now contains at least one detector 74 that previously has been shown to be located in the module 40. Thus, the new module 40 may only contain the column 18 and the heater unit 70, and the one or more detectors 74 may be disposed inside the LC device 38 and adjacent to the input port. In this embodiment, the module 40 is only used for the purposes of separation of the sample in the column 18. However, the module 40 is now able to use the different types of columns and not only ones that are transparent.

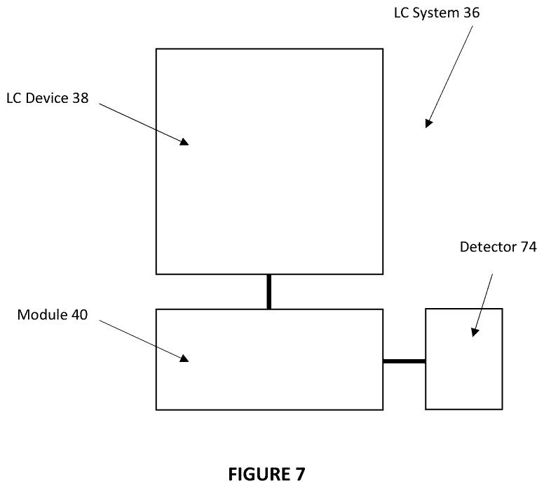

In a third embodiment of the system as shown in FIG. 7, the at least one detector 74 may not be located within the LC device 38 or the module 40, but instead is separate from both of these devices 38, 40 and is now a third separate component of the LC system 36.

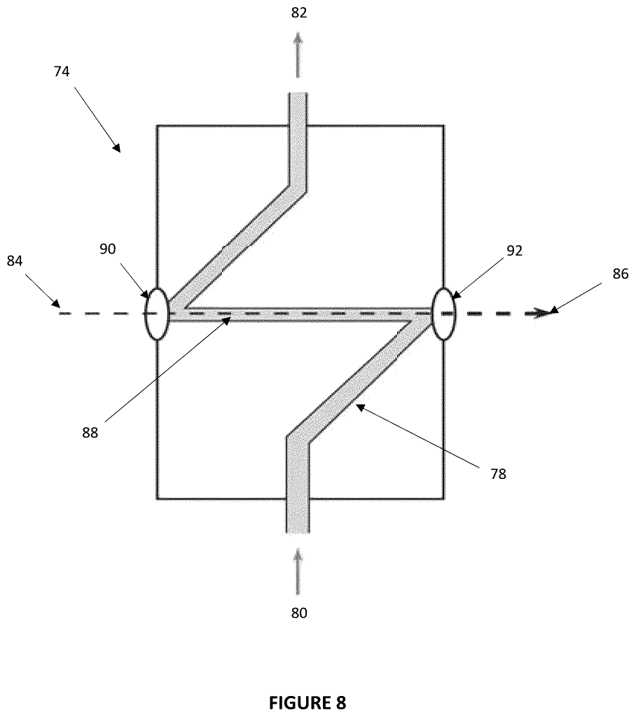

It was explained in FIG. 5 that the module in that example includes a UV-absorption flow cell detector 74 that does not use on-column detection. FIG. 8 is provided as a cross-sectional profile view of a UV absorption Z flow cell detector 74 that may be used in FIG. 5. FIG. 8 shows that the sample is delivered to the Z flow cell detector 74 by the transfer line 78 (or a flexible column) at point 80. There may be no capillary column between an input at point 80 and an exit at point 82. The path between point 80 and point 82 may simply be a hole or channel disposed in the material of the detector 74. The detector 74 then connects to the waste line 68 at point 82.

The light source 84 shines through a lengthwise section of the transfer column 78 to the detector 86 by entering the path through a window 90 and exiting through window 92. This Z flow cell detector 74 is more sensitive than on-column detectors, up to 10 times more sensitive, because as shown in FIG. 8, the light path length 88 is longer than any on-column detector path length.

Capillary high performance liquid chromatography (HPLC) provides substantial benefits in the form of reduced solvent consumption, waste, and sample volume requirements. The range of applications was limited in the past by the availability of columns of appropriate dimensions and construction. Now, a growing number of separation columns and packing media are available from a variety of vendors.

The embodiments of the present invention shown in FIGS. 5, 6, and 7 teach a compact and portable capillary LC that utilizes a module system for the exchange of columns, or columns and detectors. Earlier modules required the use of proprietary or custom-packed columns, and column heating was not available.

The heated column module of the first embodiment may accommodate capillary columns with 1.0 mm outer diameters (OD), and 0.075 to 0.500 mm inner diameters (ID), typically 5 to 25 cm lengths, stable heating up to 80° C., and fluidic configurations that maintain optimal chromatographic performance. The first embodiment may also achieve stable temperature in under 20 minutes, may hold temperature stable to within 0.1° C., and may include an inlet transfer line. The specific lengths, dimensions, and temperatures are examples only and are not limiting of the claims that follow.

This new module design may expand the possible applications by enabling controlled column heating and by accepting a wide range of capillary column dimensions from multiple open-market vendors. It may also enable straightforward column exchange, minimize potential for sub-optimal fluidic fitting connections, and includes a robust use in a range of environments.

While the embodiments above may describe a module for use with an on-column or flow cell detection system, it should be understood that the module and connection system may be adapted for use with any measurement device that requires a secure connection for the flow of a fluid between different components and should not be considered as limited to the on-column or flow cell detection systems.

A summary of the embodiments of the invention is as follows. The first embodiment is a liquid chromatography (LC) system for separating, identifying and quantifying substances in a sample. The system is comprised of two devices, an LC device and a module.

The LC device is comprised of a pump, a solvent and a sample, an injector for delivering the sample in the solvent, a connection dock for providing fluid ports to enable the injector to deliver the sample in the solvent to an output port, and a first electrical port.

The separate module that is attached to the LC device using a high pressure compression connection is comprised of a module input port for forming a high pressure seal to the output port and receiving the sample in the solvent, a second electrical port that is coupled to the first electrical port, a column coupled at a first end to the module input port for receiving the sample in the solvent, and at least one detector for performing on-column or flow cell detection of substances in the sample in the solvent, wherein the column and detector perform separating, identifying and quantifying of substances, and wherein the results of separating, identifying and quantifying of substances are transmitted from the module to a computing device using the first and the second electrical port.

The LC system may be further defined as having the output port of the connection dock further comprising a normally open output port. Similarly, the module input port further comprises a normally open module input port.

More detail regarding the possible output port of the connection dock is that it further comprises a recess or recessed frustoconical cone, and the module input port further comprises a frustoconical protrusion that is complementary and form-fitting to the recess in the output port, wherein the output port and the module input port form a leak-free high pressure compression connection.

It is an important aspect of the invention to know that the LC system further forms a high pressure compression connection that is capable of withstanding pressures greater than 1000 psi. The LC system has been tested at pressures over 10,000 psi, and it is believed it may go higher.

The high pressure compression connection system may be made possible using a knob and threaded screw. But first, to ensure that the connection is being made straight-on, there is at least one guide rail on the LC device 38 for guiding the module 40 when making the high pressure compression connection with the LC device, a ratcheting knob disposed in the LC device, and a threaded screw coupled to the ratcheting knob. The threaded screw is turned when the ratcheting knob is turned, and the threaded screw is disposed through the connection dock.

A threaded hole is also disposed in the connecting end of the module. Making sure that the threaded hole is aligned with the threaded screw of the LC device, the threaded screw is rotated through the threaded hole when the ratcheting knob is turned. The ratcheting knob prevents the threaded screw from turning when the output port of the connection dock is coupled to the module input port such that the sample in the solvent can travel from the LC device to the module.

There are some other aspects of the invention that should also be addressed. First, a detector is typically disposed in an LC device. In contrast, the embodiments of the invention illustrate the concept that both the column and one or more detectors may be disposed inside the module 40, inside the LC device 38, or external to both the module and the LC device. Thus, different detectors may be used with the same LC device 38 and are no longer dependent on the detectors provided in the LC device for the different types of measurements that can be made.

It is another aspect that a transparent or opaque column 18 of any desired length may also be paired with any type of detector 74 that may fit within the module. Thus, the LC device 38 may now be easily and rapidly coupled with any desired combination of column length and one or more detectors 74 using the module 40 and the high pressure compression connection system of the embodiments of the invention.

Another aspect of the invention is that because of the recess and protrusion high pressure compression connection system of the embodiments of the invention, the embodiments are capable of operating at both low and high pressures. For example, the embodiments of the invention are capable of operating at pressures well above 1000 psi. Accordingly, the embodiments of the invention should be considered to operate as a low and high-pressure LC system.

Another aspect of the embodiments of the invention is that each module 40 may include non-volatile memory. The non-volatile memory enables power to be removed from the module 40 without losing the contents of the memory.

The contents of the memory in the module 40 may be written to and read by the LC device 38 or any other device that can make a proper connection to the electrical port 44. The contents of the memory in the module 40 may include but should not be considered as limited to the length of the column, the type of column, the type of detector(s), the location of the detectors along the column, the number of times that the module has been used to make a measurement, and any other statistics that may be useful to a user of the module.

While it may be obvious from the description above, it should still be stated that the size of the module 40 and the LC device 38 are relatively small. For example, the LC system 36 may be portable and operated by a battery. Nevertheless, the LC system 36 may also be a desktop system that still uses the same modules 40 that may be used with the portable LC system 36. And while the module 40 may be small, it is not a requirement of the LC system 36.

The embodiments above are directed to an LC system that is divided into two or three separate components, the LC device 38, the module 40, and possibly an external detector 74 that together include all of the necessary elements to perform liquid chromatography.

A summary of such a device might be as follows. It would be an LC device comprising a pump, a solvent and a sample, an injector for delivering the sample in the solvent, a connection dock for providing an output port to enable the injector to deliver the sample in the solvent to the output port, an input port for receiving the sample in the solvent from the module, and a first electrical port.

A separate module would then be attached to the LC device using a high pressure compression connection, with the module comprising a module input port for forming a high pressure compression connection to the output port and receiving the sample in the solvent, a module output port for forming a high pressure compression connection to the input port and sending the sample in the solvent to the LC device, a second electrical port that is coupled to the first electrical port, and a column coupled at a first end to the module input port for receiving the sample in the solvent.

The LC system then either performs an on-column test inside the module, a flow cell test inside the module, a flow cell test inside the LC device, or a flow cell test in a flow cell detector that is external to both the LC device and the module.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A liquid chromatography (LC) system, said system comprising:
an LC device comprising:
a pump, a solvent and a sample;
an injector for delivering the sample in the solvent;
a connection dock for providing an output port to enable the injector to deliver the sample in the solvent to the output port, and a first electrical port; and
a separate module that is attached to the LC device,
the module comprising:
a module input port for forming a high pressure compression connection to the output port and receiving the sample in the solvent;
a second electrical port that is coupled to the first electrical port;
a first column coupled at a first end to the module input port for receiving the sample in the solvent, wherein the first column is opaque or transparent;
a heating unit;
a column oven disposed around the heating unit and at least a portion of the column; and
at least one detector for performing detection of substances in the sample in the solvent, wherein the first column and detector perform separating, identifying and quantifying of substances; and
wherein the results of separating, identifying, and quantifying of substances are transmitted from the module to a computing device using the first and the second electrical ports.

2. The LC system as defined in claim 1 wherein the at least one detector is selected from the group of detectors comprised of UV absorption detectors, photodiode array detectors, fluorescence detectors, electrochemical detectors, electrical conductivity detectors, refractive index detectors, on-column detectors, mass spectrometers, and ion mobility spectrometers.

3. The LC system as defined in claim 1 wherein the column is further comprised of at least one additional column coupled to the first column, wherein the at least one additional column may be transparent or opaque.

4. A liquid chromatography (LC) system, said system comprising:
an LC device comprising:
a pump, a solvent and a sample;
an injector for delivering the sample in the solvent;
a connection dock for providing an LC output port to enable the injector to deliver the sample in the solvent to the output port, an LC input port, and a first electrical port;
at least one detector coupled to the LC input port for receiving the sample in the solvent and for performing detection of substances in the sample in the solvent; and
a separate module that is attached to the LC device,
the module comprising:
a module input port for forming a high pressure compression connection to the LC output port and receiving the sample in the solvent;
a second electrical port that is coupled to the first electrical port;
a first column coupled at a first end to the module input port for receiving the sample in the solvent, wherein the first column is transparent or opaque, and wherein the first column is coupled at a second end to the module output port;
a heating unit;
a column oven disposed around the heating unit and at least a portion of the first column; and
wherein the results of separating, identifying and quantifying of substances are transmitted from the module to a computing device using the first and the second electrical ports.

5. The LC system as defined in claim 4 wherein the at least one detector is selected from the group of detectors comprised of UV absorption detectors, photodiode array detectors, fluorescence detectors, electrochemical detectors, electrical conductivity detectors, refractive index detectors, on-column detectors, mass spectrometers, and ion mobility spectrometers.

6. The LC system as defined in claim 4 wherein the first column is further comprised of at least one additional column coupled to the first column, wherein the additional column may be transparent or opaque.

7. A liquid chromatography (LC) system, said system comprising:
an LC device comprising:
a pump, a solvent and a sample;
an injector for delivering the sample in the solvent;
a connection dock for providing an LC output port to enable the injector to deliver the sample in the solvent to the output port, an LC input port, and a first electrical port; and
a separate module that is attached to the LC device,
the module comprising:
a module input port for forming a high pressure compression connection to the LC output port and receiving the sample in the solvent;
a second electrical port that is coupled to the first electrical port;
a first column coupled at a first end to the module input port for receiving the sample in the solvent, wherein the first column is transparent or opaque, and wherein the first column is coupled at a second end to the module output port;
a heating unit;
a column oven disposed around the heating unit and at least a portion of the first column; and
at least one detector coupled to the module output port for receiving the sample in the solvent and for performing detection of substances in the sample in the solvent, and wherein the results of separating, identifying and quantifying of substances are transmitted from the module to a computing device using the first and the second electrical ports.

8. The LC system as defined in claim 7 wherein the at least one detector is selected from the group of detectors comprised of UV absorption detectors, photodiode array detectors, fluorescence detectors, electrochemical detectors, electrical conductivity detectors, refractive index detectors, on-column detectors, mass spectrometers, and ion mobility spectrometers.

9. The LC system as defined in claim 7 wherein the first column is further comprised of at least one additional column coupled to the first column, wherein the additional column may be transparent or opaque.

10. A liquid chromatography (LC) system, said system comprising:
an LC device comprising:
a pump, a solvent and a sample;
an injector for delivering the sample in the solvent;
a connection dock for providing an output port to enable the injector to deliver the sample in the solvent to the output port, and a first electrical port; and
a separate module that is attached to the LC device,
the module comprising:
a module input port for forming a high pressure compression connection to the output port and receiving the sample in the solvent;
a second electrical port that is coupled to the first electrical port;
a first column coupled at a first end to the module input port for receiving the sample in the solvent, wherein the first column is opaque or transparent;
a heating unit;
a column oven disposed around the heating unit and at least a portion of the column; and
at least one flow cell detector for performing detection of substances in the sample in the solvent, wherein the first column and the detector perform separating, identifying and quantifying of substances; and
wherein the results of separating, identifying, and quantifying of substances are transmitted from the module to a computing device using the first and the second electrical ports.

11. A liquid chromatography (LC) system, said system comprising:
an LC device comprising:
a pump, a solvent and a sample;
an injector for delivering the sample in the solvent;
a connection dock for providing an LC output port to enable the injector to deliver the sample in the solvent to the output port, an LC input port, and a first electrical port;
at least one flow cell detector coupled to the LC input port for receiving the sample in the solvent and for performing detection of substances in the sample in the solvent; and
a separate module that is attached to the LC device,
the module comprising:
a module input port for forming a high pressure compression connection to the LC output port and receiving the sample in the solvent;
a second electrical port that is coupled to the first electrical port;
a first column coupled at a first end to the module input port for receiving the sample in the solvent, wherein the first column is transparent or opaque, and wherein the first column is coupled at a second end to the module output port;
a heating unit;
a column oven disposed around the heating unit and at least a portion of the first column; and
wherein the results of separating, identifying and quantifying of substances are transmitted from the module to a computing device using the first and the second electrical ports.

12. A liquid chromatography (LC) system, said system comprising:
an LC device comprising:
a pump, a solvent and a sample;
an injector for delivering the sample in the solvent;
a connection dock for providing an LC output port to enable the injector to deliver the sample in the solvent to the output port, an LC input port, and a first electrical port; and
a separate module that is attached to the LC device,
the module comprising:
a module input port for forming a high pressure compression connection to the LC output port and receiving the sample in the solvent;
a second electrical port that is coupled to the first electrical port;
a first column coupled at a first end to the module input port for receiving the sample in the solvent, wherein the first column is transparent or opaque, and wherein the first column is coupled at a second end to the module output port;
a heating unit;
a column oven disposed around the heating unit and at least a portion of the first column; and
at least one flow cell detector coupled to the module output port for receiving the sample in the solvent and for performing detection of substances in the sample in the solvent, and wherein the results of separating, identifying and quantifying of substances are transmitted from the module to a computing device using the first and the second electrical ports.

13. A method of performing liquid chromatography (LC) for separating, identifying and quantifying substances in a sample, said method comprising:
providing an LC device comprising a pump, a solvent and a sample, an injector for delivering the sample in the solvent, a connection dock for providing fluid ports to enable the injector to deliver the sample in the solvent to an LC output port, and a first electrical port, and
providing a separate module that is attached to the LC device, the module comprising a module input port for forming a high pressure compression connection to the LC output port and receiving the sample in the solvent, a second electrical port that is coupled to the first electrical port, a column coupled at a first end to the module input port for receiving the sample in the solvent, wherein the first column is transparent or opaque, a heating unit, a column oven disposed around the heating unit and at least a portion of the first column, and at least one detector for performing detection of substances in the sample in the solvent, wherein the column and detector perform separating, identifying and quantifying of substances,
performing LC by attaching the module to the LC device using the high pressure compression connection;
injecting the sample in the solvent to the column in the module;
separating the sample in the solvent;
identifying substances in the sample in the solvent based on how the sample interacts with sorbent material in the column;
quantifying the substances in the sample; and
transmitting data regarding the substances from the module to a computing device using the first and the second electrical port.

14. The method as defined in claim 10 wherein the method further comprises selecting the at least one detector from the group of detectors comprised of UV absorption detectors, photodiode array detectors, fluorescence detectors, electrochemical detectors, electrical conductivity detectors, refractive index detectors, on-column detectors, mass spectrometers, and ion mobility spectrometers.

15. The method as defined in claim 10 wherein the method further comprises providing an additional column coupled to the first column, wherein the additional column may be transparent or opaque.
